(19) United States
(12) Patent Application Publication
(10) Pub. No.: US 2022/0153135 A1
(43) Pub. Date: May 19, 2022

(54) LARGE FOV HUD WITH PGU IN THE CAR ROOF

(71) Applicant: Panasonic Automotive Systems Company of America, Division of Panasonic Corporation of North America, PEACHTREE CITY, GA (US)

(72) Inventors: MARKAR SOUREN NARADIKIAN, PEACHTREE CITY, GA (US); PATRICK O'CONNELL, NOVI, MI (US)

(21) Appl. No.: 17/523,330

(22) Filed: Nov. 10, 2021

Related U.S. Application Data
(60) Provisional application No. 63/113,228, filed on Nov. 13, 2020.

(51) Int. Cl. B60K 35/00

(52) U.S. Cl. CPC B60K 35/00; B60K 2370/1529; B60K 2370/785; B60K 2370/31; B60K 2370/23

(57) ABSTRACT

A motor vehicle includes a picture generation unit emitting a light field containing an image. A reflecting device is positioned to reflect the light field toward a windshield such that the light field reflects off of the windshield toward a human driver of the motor vehicle, and such that the image in the reflected light field is visible to the human driver as a virtual image. The reflecting device is at least 500 millimeters from the picture generation unit.

### CROSS-REFERENCED TO RELATED APPLICATIONS

This application claims benefit of U.S. Provisional Application No. 63/113,228, filed on Nov. 13, 2020, the disclosure of which is hereby incorporated by reference in its entirety for all purposes.

### BACKGROUND OF THE INVENTION

### 1. Field of the Invention

The present invention relates to a heads up display (HUD) of a motor vehicle.

### 2. Description of the Related Art

A heads up display emits light that reflects from the front windshield to be seen by the driver. The light appears to come from a virtual image in front of the driver and in front of the windshield. This type of head up display is currently commercially available.

Conventional head up displays create the virtual image by first using a display or picture generation unit to create an image. Next, the light from the image is reflected from one or more mirrors. Next, the light from the mirrors is directed up to the windshield and is then reflected from the windshield towards the driver. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

Current HUDs include a picture generation unit (PGU) as part of a single assembly that is disposed within the instrument panel of the car along with the other optical elements to create the image on the windshield. Placing the PGU inside of the instrument panel limits what is possible optically due to packaging constraints within the vehicle.

Currently, the field of view (FOV) of the HUD is narrow and small due to the limitations on the volume that the HUD may occupy within the instrument panel. Also, the current HUD's virtual image distance (VID) is shorter (e.g., 2.5-5.0 meters) because a larger image distance would require a larger package size. The current instrument panels are limited with regard to how much volume may be allocated to the HUD due to the presence of the cross car beam, HVAC ductwork, and the engine compartment firewall, as well as due to overall vehicle styling.

### SUMMARY OF THE INVENTION

The present invention may provide a heads up display (HUD) including a picture generation unit (PGU) that is disposed in the head liner or roof area of the motor vehicle. The PGU may be located above the driver's head near where the windshield meets the roof of the vehicle. The PGU may be disposed inside the head liner and in front of the drop down shade. The PGU may be located near the rearview mirror cluster and cameras unit, and could be integrated into this system. A HUD can be also provided for the passenger, similar to the driver's but have different content, such as point of interest information and so on. The other optical elements, such as an aspheric mirror, etc., may be located within the instrument panel. The PGU being located inside the head liner and in front of the drop down shade may enable a larger field of view (FOV), such as 10 cm×4 cm, and enable an increased virtual image distance (e.g., 10+ meters) with better image quality for augmented reality applications.

The PGU can include a liquid crystal display (LCD), light emitting diodes (LEDs), micro LED array, a projector, a CMOS display, a DMS display, a liquid crystal on silicon (LCOS) display, or a smart tablet to project an image that may be relayed thru the optical elements to create the virtual image.

The invention comprises, in one form thereof, a motor vehicle including a picture generation unit emitting a light field containing an image. A reflecting device is positioned to reflect the light field toward a windshield such that the light field reflects off of the windshield toward a human driver of the motor vehicle, and such that the image in the reflected light field is visible to the human driver as a virtual image. The reflecting device is at least 500 millimeters or more, depending on the design, from the picture generation unit.

The invention comprises, in another form thereof, a method of operating a head up display in a motor vehicle, including emitting a light field including an image. The emitting is performed by a picture generation unit. A reflecting device is positioned at least 500 millimeters from the picture generation unit and so as to reflect the light field toward a windshield of the motor vehicle such that the light field reflects off of the windshield toward a human driver of the motor vehicle, and such that the image in the reflected light field is visible to the human driver as a virtual image.

The invention comprises, in yet another form thereof, a motor vehicle including a picture generation unit attached to a roof of the vehicle and emitting a light field including an image. A reflecting device is positioned to reflect the light field toward a windshield of the vehicle such that the light field reflects off of the windshield toward a human driver of the motor vehicle, and such that the image in the reflected light field is visible to the human driver as a virtual image.

An advantage of the invention is that it provides a large distance between the PGU and the aspheric mirror without occupying more space within the instrument panel. This provides a large FOV and a longer image distance with a much better image quality than what is possible with the current HUDs that have the PGU and optical elements located within the instrument panel. According to the present invention, the PGU can be located at a distance of 500 or more millimeters from the aspheric mirror. In contrast, the current PGUs only have enough room to be located 200-300 mm from the PGU. The increased distance from the PGU to the aspheric mirror in the present invention enables a much easier optical setup to push the virtual image out to a distance much farther from the driver (e.g., 10+ meters).

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic diagram of one embodiment of a head up display arrangement of the present invention.

FIG. 2 is a flow chart of one embodiment of a method of the present invention for operating a head up display in a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

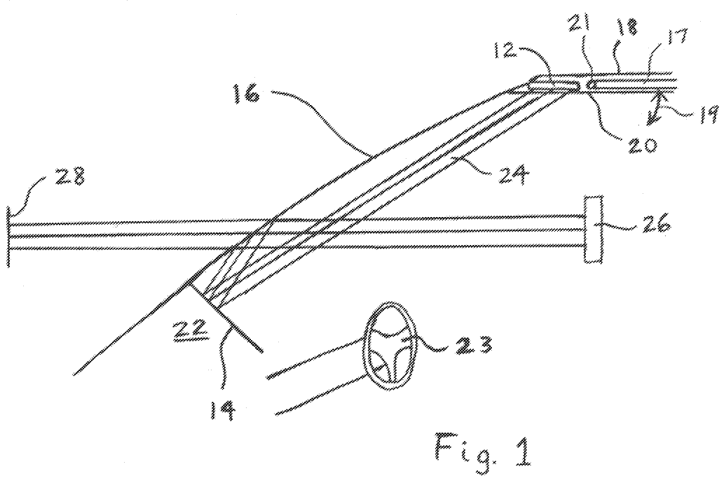

FIG. 1 illustrates one embodiment of a head up display arrangement 10 of the present invention including a picture generation unit (PGU) 12, a dash mirror/display surface 14, a windshield 16, a roof 18, and a head liner 20. PGU 12 may be attached to roof 18 and/or secured between roof 18 and head liner 20. PGU 12 may alternatively be attached to the top of the windshield and/or to the rearview mirror and/or incorporated to the lidar and/or forward camera vision system. PGU 12 may be disposed 500 millimeters or more from dash mirror/display surface 14 and/or within 200 millimeters of a top edge of windshield 16.

PGU 12 may be disposed in front of a drop down shade 17 that pivots in arcuate directions indicated by double arrow 19 about an axis 21.

Dash mirror/display surface 14 may include an aspheric mirror in or on an instrument panel 22 that reflects the image from PGU 12 onto windshield 16. The dash mirror 14 may be capable of rotating to accommodate drivers of different heights. Alternatively, there may be some type of reflective, diffusive, or holographic material on the upper surface of instrument panel 22 that reflects or creates the image and makes the image visible to driver as a reflection off of windshield 16. Instrument panel 22 is disposed in front of a steering wheel 23.

During operation, PGU 12 emits a light field 24 that is reflected by dash mirror/display surface 14 toward windshield 16. Light field 24 reflects off of windshield 16 toward a human driver whose eyes are typically within an imaginary eyebox 26. Light field 24 is visible to the driver as a virtual image 28 that appears to be several feet outside of windshield 16.

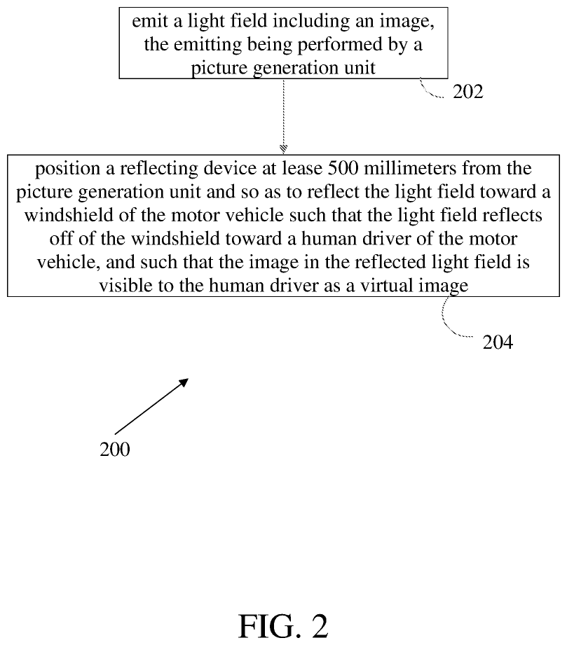

FIG. 2 illustrates one embodiment of a method 200 of the present invention for operating a head up display in a motor vehicle. In a first step 202, a light field including an image is emitted. The emitting is performed by a picture generation unit. For example, PGU 12 emits a light field 24 that includes an image.

In a final step 204, a reflecting device is positioned at least 500 millimeters from the picture generation unit and so as to reflect the light field toward a windshield of the motor vehicle such that the light field reflects off of the windshield toward a human driver of the motor vehicle, and such that the image in the reflected light field is visible to the human driver as a virtual image. For example, PGU 12 may be disposed 500 millimeters or more from dash mirror/display surface 14. Light field 24 may be reflected by dash mirror/display surface 14 toward windshield 16. Light field 24 may reflect off of windshield 16 toward a human driver. Light field 24 may be visible to the driver as a virtual image 28.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A motor vehicle comprising:
a windshield;
a picture generation unit configured to emit a light field including an image; and
a reflecting device positioned to reflect the light field toward the windshield such that the light field reflects off of the windshield toward a human driver of the motor vehicle, and such that the image in the reflected light field is visible to the human driver as a virtual image, the reflecting device being at least 500 millimeters from the picture generation unit.

2. The motor vehicle of claim 1, wherein the picture generation unit is installed within 20 centimeters of a top edge of the windshield.

3. The motor vehicle of claim 1, wherein the picture generation unit is secured between a roof and a head liner of the motor vehicle.

4. The motor vehicle of claim 1, wherein the picture generation unit is installed directly in front of a drop down shade of the motor vehicle.

5. The motor vehicle of claim 1, wherein the reflecting device is installed on or in an instrument panel of the motor vehicle.

6. The motor vehicle of claim 1, wherein the reflecting device comprises an aspheric mirror.

7. The motor vehicle of claim 1, wherein the virtual image appears to the driver to be outside of the windshield.

8. A method of operating a head up display in a motor vehicle, the method comprising:
emitting a light field including an image, the emitting being performed by a picture generation unit; and
positioning a reflecting device at least 500 millimeters from the picture generation unit and so as to reflect the light field toward a windshield of the motor vehicle such that the light field reflects off of the windshield toward a human driver of the motor vehicle, and such that the image in the reflected light field is visible to the human driver as a virtual image.

9. The method of claim 8, further comprising installing the picture generation unit within 20 centimeters of a top edge of the windshield.

10. The method of claim 8, further comprising securing the picture generation unit between a roof and a head liner of the motor vehicle.

11. The method of claim 8, further comprising installing the picture generation unit directly in front of a drop down shade of the motor vehicle.

12. The method of claim 8, further comprising installing the reflecting device on or in an instrument panel of the motor vehicle.

13. The method of claim 8, wherein the reflecting device comprises an aspheric mirror.

14. The method of claim 8, wherein the virtual image appears to the driver to be outside of the windshield.

15. A motor vehicle comprising:
a roof;
a windshield;
a picture generation unit attached to the roof and configured to emit a light field including an image; and
a reflecting device positioned to reflect the light field toward the windshield such that the light field reflects off of the windshield toward a human driver of the motor vehicle, and such that the image in the reflected light field is visible to the human driver as a virtual image.

16. The motor vehicle of claim 15, wherein the picture generation unit is installed within 20 centimeters of a top edge of the windshield.

17. The motor vehicle of claim 15, wherein the picture generation unit is secured between a roof and a head liner of the motor vehicle.

18. The motor vehicle of claim 15, wherein the picture generation unit is installed directly in front of a drop down shade of the motor vehicle.

19. The motor vehicle of claim 15, wherein the reflecting device is installed on or in an instrument panel of the motor vehicle.

20. The motor vehicle of claim 15, wherein the reflecting device is at least 500 millimeters from the picture generation unit.
